(19) United States
(12) Patent Application Publication
(10) Pub. No.: US 2003/0021573 A1
(43) Pub. Date: Jan. 30, 2003

(54) Optical fiber array

(75) Inventors: Akira Matsumoto, Nagoya-city (JP); Masashi Fukuyama, Inuyama-city (JP); Akiyoshi Ide, Kasugai-city (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/124,607

(22) Filed: Apr. 17, 2002

(30) Foreign Application Priority Data
Apr. 18, 2001 (JP) 2001-119496

(51) Int. Cl. G02B 6/36

(52) U.S. Cl. 385/137

(57) ABSTRACT

An optical fiber array of the present invention is one having an upper substrate, a lower substrate having V grooves formed on the upper side and having planar surfaces on opposite sides in a direction perpendicular to the longitudinal direction of the V grooves, and optical fibers, inserted and disposed in the V grooves, sandwiched between the upper substrate and the lower substrate. And it has a characteristic that the planar surfaces on opposite sides of the lower substrate are formed at a position lower than the upper side of the lower substrate or the top of the V grooves. This optical fiber array provides sufficient bonding reliability between constituent members, has good adhesion to other optical components, does not apply excessive stress to the optical fibers, and enables highly precise arrangement of the optical fibers.

### BACKGROUND OF THE INVENTION AND RELATED ART

The present invention relates to an optical fiber array in which optical fibers are inserted and disposed in V grooves.

In recent years, accompanied by an increase in the density of optical fibers, an increase in the number of channels of a planar lightwave circuit (PLC) has progressed. In order to further increase the density of the optical fibers while preventing an increase in the size of waveguide elements, technology for reducing a waveguide pitch to 127 μm, for example, from a conventional standard waveguide pitch (250 μm) is under development. Accompanied by the increase in the density of the optical fibers and reduction of the waveguide pitch, development of an optical fiber array (FA) connected to the optical fibers with a reduced pitch between the fibers has also progressed.

In the case where the optical waveguide has polarization dependency, or a special arrayed waveguide grating (AWG) is used to prevent four-wave mixing in wavelength division multiplexing (WDM) communications, single polarization is introduced into the waveguide by using a polarization-maintaining fiber. Since the necessary direction of polarization introduced into the waveguide is predetermined, it is necessary to adjust the end face of the polarization-maintaining fiber of the polarization-maintaining optical fiber array in this polarization direction.

FIG. 4 is an explanatory diagram showing an example of the structure of a conventional optical fiber array. In an optical fiber array 1, optical fibers 4 are disposed in V grooves 3 formed in a lower substrate 2. The optical fibers 4 are sandwiched between the lower substrate 2 and an upper substrate 5. An adhesive layer 7 is formed between the upper substrate 5 and the planar surfaces (opposite-side planar surfaces 6) formed on opposite sides of the lower substrate 2. Spaces 8 around the optical fibers 4 and the adhesive layer 7 are filled with an adhesive for securing the optical fibers 4. The optical fiber array 1 is formed in this manner. The adhesive layer 7 must have a thickness d of 10 μm or more in order to exhibit sufficient adhesiveness to provide sufficient reliability for the optical fiber array 1.

The adhesive layer 7 shown in FIG. 4 preferably has a thickness d of about several to 20 microns in order to exhibit good adhesiveness. However, if the thickness d is set within this range, the thickness of the adhesive with which the space 8 is filled may become about 50 μm. Since the adhesive shows cure shrinkage of about 1-10 vol %, shrinkage stress remains. Moreover, occurrence of stress due to the difference in shrinkage and expansion by thermal variation may cause a decrease in long-term reliability of the optical fiber array.

FIG. 7 is an explanatory diagram showing a bonding state between the optical fiber array and a waveguide chip. The optical fiber array 1 and the waveguide chip 11 are generally bonded by forming an adhesive layer 12 using an adhesive. An end face 13 of the optical fiber array 1 formed of the adhesive is in contact with the adhesive shown in FIG. 4 with which the space 8 is filled. However, since the shape of the adhesive with which the space 8 is filled is not uniform or impurities easily adhere to the adhesive, a bonding state between the optical fiber array 1 and the waveguide chip 11 becomes non-uniform, thereby causing deterioration of bonding. The adhesive with which the space 8 is filled closely adheres to the optical fiber 4 and is present near the core of the optical fiber 4. Therefore, in the case where bonding deterioration is increased, the core of the optical fiber 4 may be adversely affected, whereby reflection, loss, or the like may occur.

Furthermore, since two types of adhesives are in contact with each other between the adhesive with which the space 8 shown in FIG. 4 is filled and the end face 13 shown in FIG. 7, the bonding state may be affected by the shape of the adhesives. Therefore, it is difficult to secure a stable bonding state.

There is a case where humidity is applied after connecting the optical fiber array with the waveguide chip or the like as an external environmental factor. In this case, humidity may reach the optical fiber array. This may cause swelling of the adhesive with which the space 8 shown in FIG. 4 is filled, whereby the adhesive may project. As a result, unnecessary stress may be applied to the end face 13 shown in FIG. 7 due to the projecting adhesive, whereby bonding deterioration may occur in the contact area between the end face 13 and the adhesive with which the space 8 is filled.

In order to form a polarization-maintaining optical fiber array having a multi-core structure, it is necessary to mount the polarization-maintaining fibers in the V grooves so that only a small amount of stress is applied. Moreover, a structure and method capable of precisely adjusting the angle of all the polarization-maintaining fibers are necessary. This is because the polarization properties of the polarization-maintaining fiber may deteriorate from only a small amount of external stress, and the polarization-maintaining fibers are optical components very sensitive to polarization.

In the case of forming an optical fiber array, a three-point contact structure in which the optical fibers are caused to abut on the V grooves and are pressed against the V grooves using the upper substrate is employed in order to secure the arrangement precision of the optical fibers. FIG. 5 is an explanatory diagram showing an example of the structure of a conventional polarization-maintaining optical fiber array. Specifically, in the case of employing the three-point contact structure when forming the polarization-maintaining optical fiber array 16, stress applied from the lower substrate 2 and the upper substrate 5 or stress caused by shrinkage of the adhesive or the like may be concentrated on the polarization-maintaining fibers 17, whereby the polarization properties may deteriorate.

Moreover, the polarization-maintaining fibers 17 cannot be rotated after the polarization-maintaining fibers 17 are caused to be in contact at three points. Therefore, it is indispensable to carry out a procedure consisting of making fine adjustment of the angle in a state in which the upper substrate 5 floats, causing the upper substrate 5 to abut on the polarization-maintaining fibers 17, and securing the polarization-maintaining fibers 17 by filling the space with an adhesive. However, the polarization-maintaining fibers 17 may be rotated to a small extent when causing the upper substrate 5 to abut on the polarization-maintaining fibers 17, whereby the angle of the polarization-maintaining fiber 17 may deviate from the adjusted angle.

In order to solve the above problems, as shown in FIG. 6, there has been proposed a method of securing the arrangement precision of the polarization-maintaining fibers 17 by adjusting the diameter of the inscribed circle of the V grooves to about 0.5 μm larger than the diameter of the polarization-maintaining fibers 17, specifically, by forming a very small clearance instead of forming a polarization-maintaining optical fiber array 16 with a three-point contact structure. However, according to this method, since the upper substrate 5 is caused to abut on the opposite-side planar surfaces 6 of the lower substrate 2, an adhesive layer with a sufficient thickness d cannot be secured between the substrates. Moreover, since the polarization-maintaining fibers 17 are submerged in the V grooves 3 (hereinafter called “fiber-submerged structure”), it is difficult to secure a desired adhesive layer. Specifically, bonding reliability may become insufficient in the polarization-maintaining optical fiber array having the fiber-submerged structure.

In the case of aligning lensed fibers having a tip provided with a lensed processing, it is necessary to make a fine adjustment of the lensed fibers in the longitudinal direction in the order of several microns. Suppose that the optical fiber array has a three-point contact structure in which the lensed fibers are caused to abut on the V grooves while adjusting the position and are pressed against the V grooves using the upper substrate. In this case, since the upper sides of the V grooves are not closed when adjusting the position of the lensed fibers in the V grooves, the lensed fibers may float to a small extent when moved in the longitudinal direction. Specifically, the lensed fibers are moved not only in the longitudinal direction, but also in other directions. This hinders fine adjustment in the order of several microns.

In order to solve such a hindrance, the lensed optical fiber array may be formed to have the fiber-submerged structure in the same manner as in the polarization-maintaining optical fiber array 16 shown in FIG. 6. In this case, it is possible to make a fine adjustment of the position of the lensed fibers in the longitudinal direction in a state in which the upper substrate is provided in advance. However, since the thickness of the adhesive layer is insufficient, bonding reliability of the resulting lensed optical fiber array may become insufficient.

The present invention has been achieved in view of the above-described problems in the conventional art. Accordingly, an object of the present invention is to provide an optical fiber array having sufficient bonding reliability between the constituent members, exhibiting good adhesiveness with other optical components, and enabling the optical fibers to be disposed with high precision while preventing excessive stress from being applied to the optical fibers.

### SUMMARY OF THE INVENTION

Specifically, the present invention provides an optical fiber array comprising an upper substrate, a lower substrate having V grooves formed on the upper side and having planar surfaces on opposite sides in a direction perpendicular to the longitudinal direction of the V grooves, and optical fibers, inserted and disposed in the V grooves, sandwiched between the upper substrate and the lower substrate, characterized in that the planar surfaces on opposite sides of the lower substrate are formed at a position lower than the upper side of the lower substrate or the top of the V grooves. In the present invention, the upper side of the lower substrate and the top of the V grooves are preferably formed at the same position in the vertical direction. The slope angle of the V grooves preferably has at least two angles.

In the present invention, the optical fibers are preferably polarization-maintaining fibers and/or lensed fibers. In the present invention, the upper side of the lower substrate or the top of the V grooves is preferably formed at a position higher than the uppermost part of the optical fibers.

### BRIEF DESCRIPTION OF THE DRAWINGS

FIG. 1 is an explanatory diagram showing one embodiment of an optical fiber array of the present invention.

FIG. 2 is an explanatory diagram showing another embodiment of the optical fiber array of the present invention.

FIG. 3 is an explanatory diagram showing still another embodiment of the optical fiber array of the present invention.

FIG. 4 is an explanatory diagram showing an example of the structure of a conventional optical fiber array.

FIG. 5 is an explanatory diagram showing an example of the structure of a conventional polarization-maintaining optical fiber array.

FIG. 6 is an explanatory diagram showing another example of the structure of a conventional polarization-maintaining optical fiber array.

FIG. 7 is an explanatory diagram showing a bonding state between the optical fiber array and a waveguide chip.

FIGS. 8(a) to 8(c) are explanatory diagrams showing steps of forming a mold.

FIG. 9 is an explanatory diagram showing an example in which a lower substrate used for the optical fiber array of the present invention is formed by press forming.

FIG. 10 is an explanatory diagram showing still another embodiment of the optical fiber array of the present invention.

### DESCRIPTION OF PREFERRED EMBODIMENT OF THE INVENTION

Embodiments of the present invention are described below in detail with reference to the drawings. However, the present invention is not limited to these embodiments.

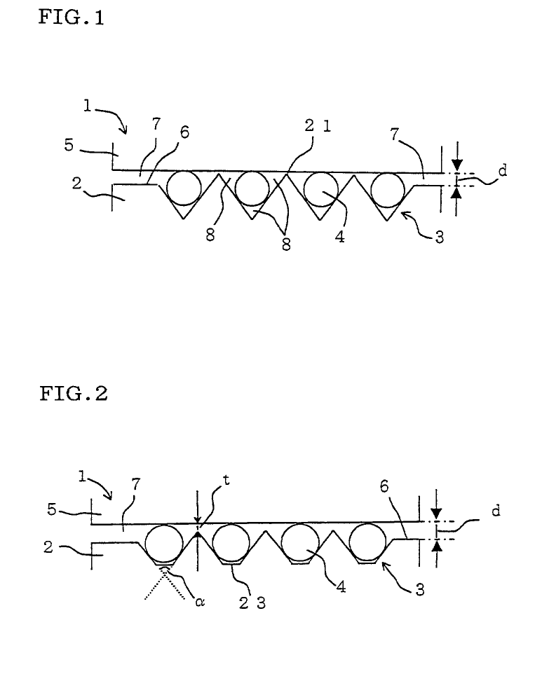

FIG. 1 is an explanatory diagram showing one embodiment of an optical fiber array of the present invention. The optical fiber array shown in FIG. 1 includes an upper substrate 5 and a lower substrate 2 which has V grooves 3 formed on the upper side and has planar surfaces on opposite sides in a direction perpendicular to the longitudinal direction of the V grooves 3 (opposite-side planar surfaces 6). Optical fibers 4, inserted and disposed in the V grooves 3, are sandwiched between the upper substrate 5 and the lower substrate 2. In the optical fiber array 1 of the present embodiment, the opposite-side planar surfaces 6 are formed at a position lower than the upper side (not shown) of the lower substrate 2 or the top 21 of the V grooves 3.

In the present invention, the opposite-side planar surfaces 6 are formed at a position lower than the upper side of the lower substrate 2 or the top 21 of the V grooves 3. Therefore, the amount of adhesive with which a space 8 around the optical fibers 4 is filled is decreased. Therefore, stress applied to the optical fibers 4 due to cure shrinkage of the adhesive, thermal variation, and the like is decreased. As a result, the optical fiber array of the present invention is provided with long-term reliability because a problem such as a loss rarely occurs. Moreover, since the amount of stress caused by projection of the adhesive due to swelling is reduced by decreasing the amount of adhesive to be used, deterioration of bonding between the optical fiber array and a waveguide chip or the like can be prevented.

Furthermore, an adhesive layer 7 having a thickness d corresponding to the difference between the vertical position of the top 21 of the V grooves 3 and the vertical position of the opposite-side planar surfaces 6 of the lower substrate 2 is secured. Therefore, the optical fiber array has sufficient reliability relating to bonding between the constituent members. The thickness d of the adhesive layer 7 may be changed depending upon the size of each constituent member and the like. The thickness d of the adhesive layer 7 is preferably 10-50 μm, and still more preferably 10-40 μm in order to secure sufficient adhesiveness and decrease the amount of adhesive to be used.

Since the amount of adhesive to be used is decreased, conditions of the end face of the optical fiber array formed by the adhesive, specifically, conditions of a bonding surface with other optical components such as a waveguide chip are improved. Moreover, the amount of stress caused by projection of the adhesive due to swelling is decreased. As a result, deterioration of bonding between the optical fiber array and the waveguide chip or the like can be prevented. Therefore, the optical fiber array has long-term reliability.

FIG. 1 illustrates a structure in which the top 21 of the V grooves 3 and the optical fibers 4 are in contact with the upper substrate 5. However, the present invention is not limited to this embodiment. The optical fiber array may have a structure in which either the top of the V grooves or the optical fibers are in contact with the upper substrate. In the case where the optical fiber array has a structure in which the top of the V grooves is in contact with the upper substrate, it is preferable to form the top of the V grooves in the shape of a planar surface or a curved surface instead of forming the top of the V grooves at an acute angle. This prevents occurrence of scratching or cracks in the fibers even if the optical fibers collide with the top of the V grooves when placing and aligning the optical fibers in the V grooves, since the top of the V grooves is not sharpened. This also prevents occurrence of cracks in the lower substrate.

In the present invention, it is preferable to form the upper side of the lower substrate or the top of the V grooves at the same vertical position. This enables a plurality of optical fibers to be disposed uniformly without causing uneven distribution when placing and aligning the optical fibers in the V grooves. For example, in the case of securing the optical fibers using an adhesive, distribution of stress caused by cure shrinkage or thermal expansion of the adhesive becomes uniform because the adhesive has a uniform thickness. This enables realization of very stable quality. If the stress distribution is nonuniform, partial delamination or deterioration of quality may occur.

FIG. 2 is an explanatory diagram showing another embodiment of the optical fiber array of the present invention. In the present embodiment, the slope angle of the V grooves 3 preferably has at least two angles. The amount of adhesive to be used can be decreased by forming the V grooves in the shape of such a multi-angled structure. This reduces occurrence of stress due to cure shrinkage or thermal expansion of the adhesive, whereby the optical fibers are less affected.

Since the amount of adhesive to be used is decreased, deterioration of bonding between the optical fiber array and the waveguide chip or the like can be prevented because not only the conditions of the end face of the optical fiber array formed by the adhesive, specifically, the bonding surface with other optical components such as a waveguide chip, are improved, but also the amount of stress caused by projection of the adhesive due to swelling is decreased. Therefore, the optical fiber array has long-term reliability. The above embodiments illustrate the case where the cross section of the lower substrate is in the shape of the letter V. However, the present invention is not limited to these embodiments. For example, the cross section of the lower substrate may be in the shape of the letter U.

In the present invention, the optical fibers are preferably polarization-maintaining fibers. The optical fiber array of the present invention has a structure which rarely causes an excessive stress to be applied to the optical fibers since the amount of adhesive to be used is decreased and sufficient bonding reliability is provided. Therefore, a problem such as deterioration of polarization properties rarely occurs even in the case of using the polarization-maintaining fibers.

In the present invention, the optical fiber array preferably has a fiber-submerged structure in which the upper side of the lower substrate or the top of the V grooves is formed at a position higher than the uppermost part of the optical fiber. Further details are described below with reference to the drawings taking the case of using the polarization-maintaining fibers as an example.

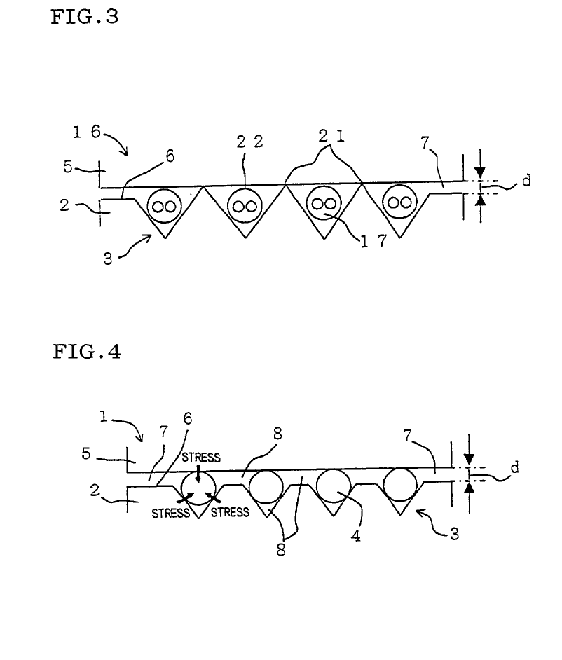

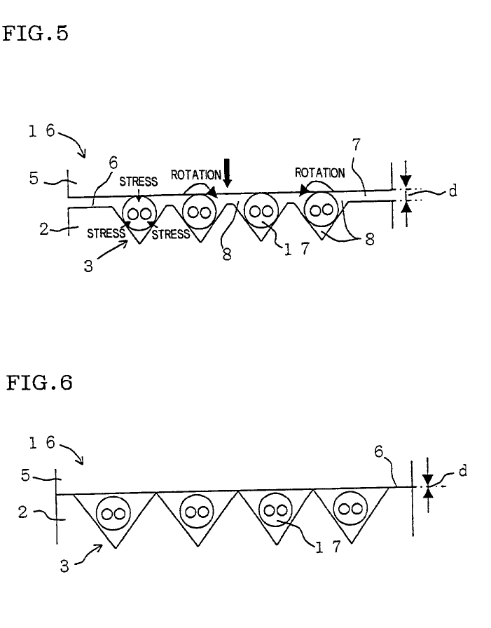

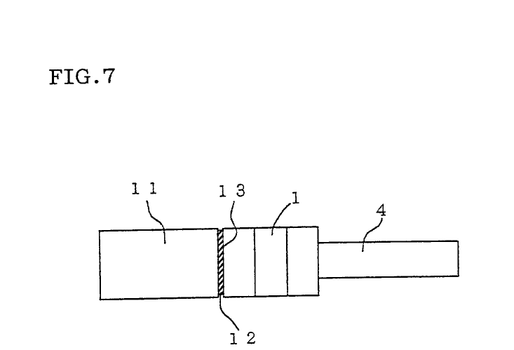

FIG. 3 is an explanatory diagram showing still another embodiment of the optical fiber array of the present invention. FIG. 3 illustrates a polarization-maintaining optical fiber array 16 in which the top 21 of the V grooves 3 is formed at a position higher than an uppermost part 22 of polarization-maintaining fibers 17. Specifically, the polarization-maintaining optical fiber array 16 preferably has a fiber-submerged structure in which the uppermost part 22 is not in contact with the upper substrate 5 whereby the polarization-maintaining fibers 17 are submerged in the V grooves 3. This enables the adhesive to be cured after causing the upper substrate 5 to abut on the top 21 of the V grooves 3 and making adjustment of the angle by rotating the polarization-maintaining fibers 17. Therefore, in the optical fiber array of this embodiment, occurrence of angular deviation due to contact between the upper substrate and the optical fibers can be prevented differing from conventional optical fiber arrays.

Moreover, since the optical fibers are not pressed by the upper substrate, stress applied to the optical fibers is controlled. In addition, a sufficient adhesive layer can be secured.

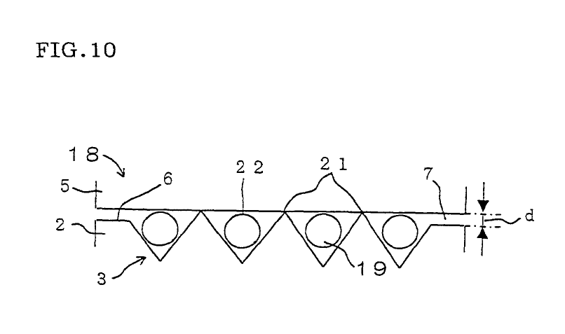

FIG. 10 is an explanatory diagram showing still another embodiment of the optical fiber array of the present invention. FIG. 10 illustrates a state in which the top 21 of the V grooves 3 is formed at a position higher than the uppermost part 22 of the lensed fibers 19. Specifically, this optical fiber array (lensed optical fiber array 18) has a fiber-submerged structure in which the uppermost part 22 is not in contact with the upper substrate 5 whereby the lensed fibers 19 are submerged in the V grooves 3. In this structure, since narrow spaces (V grooves 3) are previously formed by placing the upper substrate 5 so as to be in contact with the top 21 of the V grooves 3 in the lower substrate 2, these narrow spaces function as guides for adjustment of the position of the lensed fibers in the longitudinal direction. Therefore, the optical fiber array (lensed optical fiber array 18) of the present invention enables fine adjustment of the position of the lensed fibers 19 with ease and has excellent bonding reliability due to the possession of the adhesive layer 7 having a sufficient thickness d.

A method of forming the lower substrate used in the optical fiber array of the present invention is described below. The upper substrate, lower substrate, and the like which make up the optical fiber array are formed using a light-transmitting glass material or plastic material. Use of a glass material is preferable due to good light transmissivity and a small coefficient of thermal expansion. As a method for forming the lower substrate having a specific structure as in the present invention using a glass material, a grinding method, press forming (reheat press forming) method, and the like can be given.

In the grinding method, a glass material cut into a specific size is secured on a grinder, and V-shaped grooves are ground into the surface.

In the press forming method, a glass material cut to a specific size is press-formed using a mold having V-shaped convexities, thereby transferring the V-shaped grooves to the glass material.

The adhesive used for the optical fiber array of the present invention is described below. It is preferable that the adhesive used for the optical fiber array of the present invention be cured in a short period of time. If a considerable period of time is required for curing of the adhesive, the fiber may be moved from the state adjusted by rotating the fiber, whereby the adjusted fiber angle may deviate.

Therefore, use of adhesive which is cured at least within 10 minutes is preferable. For example, a photocurable adhesive such as a UV adhesive can be cured in a very short period of time of five minutes or less. Moreover, the adjusted fiber angle is not adversely affected due to viscosity variation during heating, differing from the case of using a heat-curable adhesive. It is particularly preferable to use a urethane acrylate resin or the like which is used as a common coating material.

The present invention is described below in more detail by examples. However, the present invention is not limited to the following examples.

### EXAMPLES

A lower substrate 2 for a 16-core optical fiber array was prepared so as to have a structure in which the V grooves 3 had an angle a of 70°, a bottom 23 of the V groove 3 was planar, thickness d of the adhesive layer 7 was 30 μm, and a distance t between the top 21 of the V grooves 3 and the upper substrate 5 was 5 μm. Specifically, the top 21 of the V groove 3 was not in contact with the upper substrate 5. The optical fiber array 1 was prepared using this lower substrate 2. The lower substrate 2 was prepared using a grinding process and a press forming process. The preparation method of the lower substrate is described below.

(Grinding Process)

V grooves were formed in a glass material according to a conventional method. Portions which become the opposite-side planar surfaces were processed using a surface grinder provided with a #800 diamond grinding wheel to obtain a lower substrate having a specific shape.

(Press Forming Process)

A method of forming a V groove mold used for the press forming process is described below.

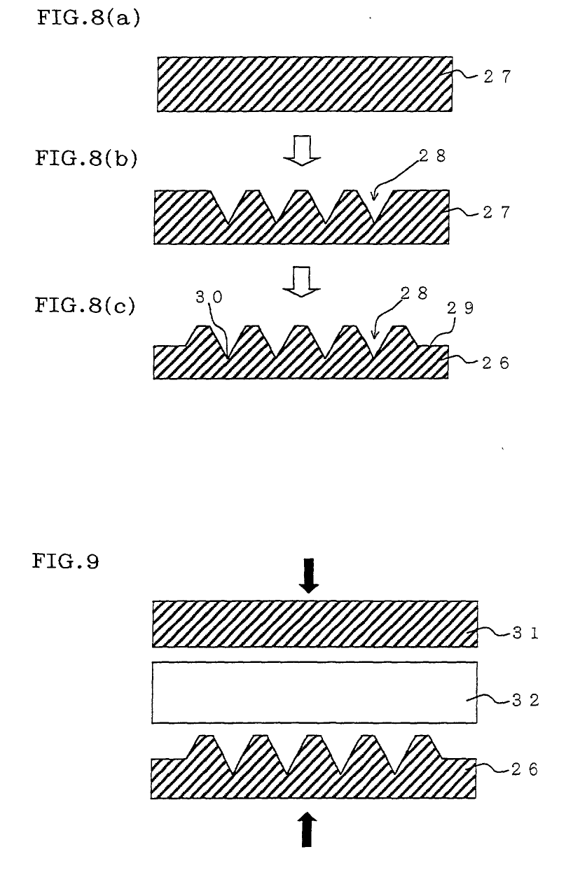

1. Formation of V groove mold: A V groove mold 26 was formed by the steps shown in FIGS. 8(a) to 8(c). A super-hard mold material 27 (FIG. 8(a)) was provided. Grooves 28 were ground using a #1200 metal grinding wheel (FIG. 8(b)), and opposite-side planar surface abutting sections 29 were ground (FIG. 8(c)). The opposite-side planar surface abutting sections 29 were processed at a position 25 μm higher than the deepest groove sections 30. A noble metal thin film with a thickness of about 3 μm was formed on the mold as a protective film to form the V groove mold 26.

2. Press forming: A glass material 32 was press-formed using an upper mold 31 and the V groove mold 26 at 700° C. in an N₂ atmosphere while applying a pressure of 4 MPa in the vertical direction to obtain a lower substrate having a specific shape.

(Formation of Optical Fiber Array)

The lower substrate obtained by the above grinding process and press forming process was cut into chips. An optical fiber array was obtained by assembling and polishing constituent members according to a conventional method.

As described above, since the planar surfaces on opposite sides of the lower substrate are formed at a position lower than the upper side of the lower substrate or the top of the V grooves, the optical fiber array of the present invention has sufficient bonding reliability between the constituent members and excels in adhesion to other optical components while decreasing the amount of adhesive. Moreover, since the optical fibers can be disposed with high precision without causing an excessive stress to be applied, problems such as deterioration of polarization properties rarely occur even in the case of using the polarization-maintaining fibers.

What is claimed is:

1. An optical fiber array comprising an upper substrate, a lower substrate having V grooves formed on the upper side and having planar surfaces on opposite sides in a direction perpendicular to the longitudinal direction of the V grooves, and optical fibers, inserted and disposed in the V grooves, sandwiched between the upper substrate and the lower substrate,
characterized in that the planar surfaces on opposite sides of the lower substrate are formed at a position lower than the upper side of the lower substrate or the top of the V grooves.

2. The optical fiber array according to claim 1, wherein the upper side of the lower substrate and the top of the V grooves are formed at the same position in the vertical direction.

3. The optical fiber array according to claim 1, wherein the slope angle of the V grooves has at least two angles.

4. The optical fiber array according to claim 2, wherein the slope angle of the V grooves has at least two angles.

5. The optical fiber array according to claim 1, wherein the optical fibers are polarization-maintaining fibers and/or lensed fibers.

6. The optical fiber array according to claim 2, wherein the optical fibers are polarization-maintaining fibers and/or lensed fibers.

7. The optical fiber array according to claim 3, wherein the optical fibers are polarization-maintaining fibers and/or lensed fibers.

8. The optical fiber array according to claim 4, wherein the optical fibers are polarization-maintaining fibers and/or lensed fibers.

9. The optical fiber array according to claim 1, wherein the upper side of the lower substrate or the top of the V grooves is formed at a position higher than the uppermost part of the optical fibers.

10. The optical fiber array according to claim 2, wherein the upper side of the lower substrate or the top of the V grooves is formed at a position higher than the uppermost part of the optical fibers.

11. The optical fiber array according to claim 4, wherein the upper side of the lower substrate or the top of the V grooves is formed at a position higher than the uppermost part of the optical fibers.
